(19) United States
(12) Patent Application Publication
(10) Pub. No.: US 2019/0022987 A1
(43) Pub. Date: Jan. 24, 2019

(54) Removable, Reusable Mount for Plastic Foam Laminates on Architectural Glass and Kit

(71) Applicant: Mark Anthony Shippen, Prattville, AL (US)

(72) Inventor: Mark Anthony Shippen, Prattville, AL (US)

(21) Appl. No.: 15/655,541

(22) Filed: Jul. 20, 2017

(51) Int. Cl. B32B 27/06; B32B 27/08; E06B 3/263; C03C 27/00; C03C 17/34

(52) U.S. Cl. CPC B32B 27/065; B32B 27/08; E06B 3/26305; C03C 27/00; E06B 2003/26378; C03C 17/3482; B32B 2307/304; E06B 2003/26309; C03C 17/3405

(57) ABSTRACT

An optically clear, siliconized plastic film(1) adhesively mounted on an architectural glass substrate(7) creates a highly efficient seat for adhere able plastic foam laminates. This will allow the plastic foam laminates to be seated on the siliconized plastic film creating complete removability and reusability. Additionally, numerous adhesives can be specified for the plastic foam laminates wherein adhesive residue left on the glass will not be a design factor. In one embodiment the siliconized plastic film allows double sided tape(2) to be placed on the periphery of the laminate to achieve an excellent, glass removable bond for seating the film on a glass substrate. This makes an excellent, impervious seal. Also, heat transfer reductions range from approximately 89-98% depending upon the temperature extremes in Winter and Summer. Further, this invention provides good light transmission, improves privacy for bedroom glass, creates a display for brilliant artwork, reduces dust accumulations and creates instant removability. The material cuts as easy as paper and will be very simple to fabricate; therefore, this invention can be constructed with simple kits and installed by unskilled, do-it-yourself users.

### FIELD OF INVENTION

Plastic polyolefin heat shrink films are used to reduce winter drafts coming through windows and glass doors. However, these plastic films do not yield significant insulation because there are leaky gaps between movable windows and the tracks of sliding glass doors. Additionally, a ½ inch(12.7 mm) space is required to achieve a 1R insulation value. Plastic olefin films are almost never applied optimally. Also, water vapor can enter through these gaps. Only an impervious seal will yield significant insulation. Masking an air draft is not the same as insulating glass. This new design seals out air and water vapor infiltration by mounting an optically clear, siliconized plastic film directly to glass with practically no air space between the architectural glass and the plastic film. Then, almost any plastic foam insulation such as disclosed in Shippen(Ser. No. 14/297,548) fabricated with almost any type of adhesive can be adhered to a glass mounted, siliconized film. The new advantage is that the plastic foam insulation structure can adhere and be removed hundreds of times whenever a clear view through the glass is desired. Also, this mount will comprise a minimally invasive adhesive application to the glass. Therefore, this invention will satisfy the long desire of insulating glass to save energy and to add more comfort in homes and other buildings.

### PRIOR ART

Shippen (U.S. Pat. No. 5,108,811), (Ser. No. 14/297,548) this inventor, specifies a reusable adhesive applied directly to glass and makes no reference to a siliconized, optically clear plastic film for mounting a plastic foam laminate. Just as the plastic foam was heretofore considered a throw away material, so is the siliconized plastic film considered a throw away material. Now, ironically, the foam and the film comprise a much more valuable, reusable insulation material that can mimic stained glass and adds the insulation value of about ten extra layers of glass. It can be removed from the siliconized film easier than a banana is peeled. The clear, siliconized plastic film remains on the glass almost unnoticeable and durable for many years of service.

### EMBODIMENTS

The base material is optically clear, siliconized on one side, plastic film. Manufactures can mass produce such film in 1 to 5 mil (0.0254 to 0.127 mm) thickness. The specification of thickness is made based upon the best appearance applied upon the glass for both inside and outside views. The siliconization film process allows different compositions to be specified. However, a release bond of (76±25 g/in) works well. The plastic film is comprised of standard siliconized film including uv protected petg, vinyl or polyester. Unlike the disposable heat shrink films currently used for insulation, the siliconized, optically clear plastic films of this invention lay flat and tight and can be cleaned easily with no seasonal replacement. And siliconized film is readily supplied in a kit.

Another embodiment is a water resistant, double sided adhesive tape for direct bonding to glass and to the non-siliconized side of plastic film. A 40/16 ounce per inch differential, solvent based acrylic has been tested for more than four years. It works well and is easily removed from glass with no residual deposit. This double sided tape ½ (12.7 mm) to ¾ (19.05 mm) width is easily applied around the periphery of the non-siliconized plastic film forming an impervious seal and adheres the film to architectural glass. Static cling of the plastic film further helps the bond to glass. Even if an optically clear tape were used and a very small cleanup job resulted after many years of use, its use is justified. A very large, glass clear viewing area is formed with the residual tape having a minimal profile. The film may also be adhered to the glass permanently like a tinting film. Glass clear, aqueous based glue can be used with a squeegee to clear wrinkles and bubbles. The economic value of this invention does make this option a viable glass modification, but using tape is very easy and efficacious.

Another element of this invention is a plastic foam insulation laminate. Such laminates are disclosed in Shippen(U.S. Ser. No. 14/297,548). The plastic foam laminate provides excellent insulation value, privacy, light transmission and decorative lighting effects. Another advantage of using a siliconized mounting film for plastic foam laminates is that minimal adhesive contact with the glass is created. Also, an expanded use of adhesives on the plastic foam laminate is created since adhesive deposits on the glass will not have to be accounted. 100% adhesive coverage on the glass side of the plastic foam laminate is recommended. Uv resistant adhesives are preferred including acrylic, solvent based acrylics and silicones. Optically glass clear adhesives are attractive. However, transfer film adhesives without carrier films are now preferred because these produce the best optical quality by eliminating air pocket bubbles and undesirable, adhesive film reflection in most of the finished products. Acrylics and silicone transfer films work well and are recommended. Further, the plastic siliconized film is presented with the siliconized side down, adhered wrinkle free, and with the adhesive face not exposed to air on the plastic foam laminate. This allows for easy cutting, taping, transferring and glass mounting. For widespread commercial use, optical quality is the key. Conveniently, plastic foam laminates are light weight and easily supplied in a kit box.

### DRAWINGS

FIG. 1 Shows an optically clear siliconized plastic film (1) with a double sided adhesive tape (2) placed around he periphery of the plastic film overlapping at the corners(3).

FIG. 2 Shows the plastic film (1) manufactured with a siliconized surface (4) and a second surface with a non-siliconized surface (5).

FIG. 3 Shows a glass clear, aqueous glue composition (8) bonding the plastic film (1) to the glass substrate (7).

FIG. 4 Illustrates the finished multi-layers of a typical plastic foam laminate bonded to the glass substrate completing the invention.

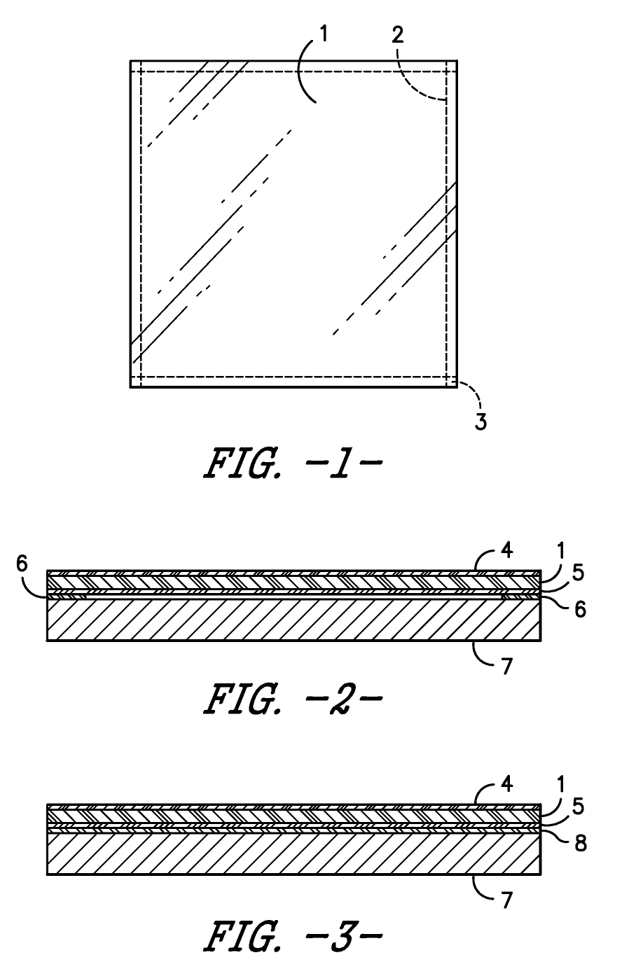

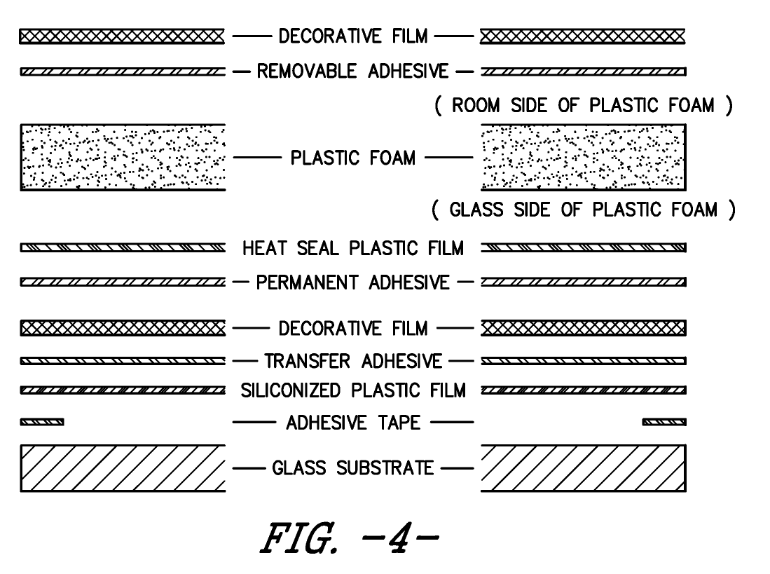

### DIRECTIONS FOR INSTALLATION

1) Clean the glass thoroughly and cloth dry.
2) Measure the desired coverage with a tape measure or the like.
3) Mark off the dimensions on the plastic foam laminate.
4) Cut the piece of foam laminate with a pair of scissors.
5) The siliconized plastic film is presented on the plastic foam laminate face down. Therefore, there should be no question which side is siliconized. On the corner where you wish to remove the laminate from glass, separate a very small corner between the siliconized film and the foam laminate. Cut with scissors, about a ¼ inch corner clipping from the laminate. Or alternately, put a small adhesive tape tab on the plastic foam laminate. Now you will see and identify the releasable corner as the designated starting point to pull the laminate from the seated siliconized plastic film. Easy, clean separation can be accomplished many, repeatable times.
6) Next, take the roll of double sided tape and cut a strip of tape. Place it on one edge of the laminate's plastic film. Remove the tape liner after setting the tape. Overlap the tape strips at each corner until all four corners have overlapping tape strips.
7) Now you can carefully press on the tape side laminate to the measured glass space to achieve a removable and reusable mount for plastic foam laminates.

### Comments

Finally, this invention could save many lives lost in home fires due to the desperate use of space heaters in cold extremes. It will also relieve the stress on electrical heaters reducing fires from their overuse. Undoubtedly, a thirty to sixty percent reduction of the heating load in a domicile will save many lives. A financial windfall of utility savings will enrich users of this invention. And less pollution benefits countless people across the Earth, reduces collateral water pollution, improves the condition of our biosphere and cleans the air we all breathe.

I claim:

1) For adhering to architectural glass removable, reusable mount for a plastic foam laminate comprising:
a) a removable from glass adhesive layer deposited on a glass substrate adhered to;
b) an optically clear, plastic film having on one side a siliconized deposit and having a second non-siliconized side adhered to said removable from glass adhesive layer and;
c) a plastic foam laminate having an adhesive side adhered to the siliconized side of the optically clear, plastic film.

2) The removable, reusable mount of claim 1 wherein the adhesive layer deposited on glass comprises a clear, double sided adhesive tape.

3) The removable, reusable mount of claim 1 wherein the adhesive layer deposited on glass comprises an optically clear, aqueous glue.

4) The removable, reusable mount of claim 1 wherein the plastic foam laminate comprises an adhesive, carrier less transfer film composition.

5) The adhesive, carrier less transfer film composition of claim 4 comprising an adhesive composition from the group including acrylic and silicone.

6) The removable, reusable mount of claim 1 wherein the plastic foam laminate comprises an adhesive composition with 100% coverage on the glass side.

7) The removable, reusable mount of claim 1 wherein the plastic foam laminate comprises an adhesive composition that is optically, glass clear.

8) A kit comprising a plastic foam laminate, adhesive tape removable from glass and a clear plastic film comprising at least on one side, a siliconized deposit.

9) A kit comprising an adhesive tape removable from glass, and a plastic foam laminate with a clear plastic film having a siliconized side and a non-siliconized side wherein the siliconized side covers the air exposed adhesive side on said plastic foam laminate.
